(19) United States
(12) Patent Application Publication
(10) Pub. No.: US 2023/0303878 A1
(43) Pub. Date: Sep. 28, 2023

(54) Ink Set

(71) Applicant: SEIKO EPSON CORPORATION, Tokyo (JP)

(72) Inventors: Shigeki KAWADA, Shiojiri (JP); Kenta KIKUCHI, Suwa (JP); Tetsuya AOYAMA, Shiojiri (JP); Hiroaki KUMETA, Matsumoto (JP)

(21) Appl. No.: 18/188,572

(22) Filed: Mar. 23, 2023

(30) Foreign Application Priority Data
Mar. 24, 2022 (JP) 2022-047966

(51) Int. Cl. C09D 11/40; C09D 11/328; C09D 11/38; C09D 11/037; C09D 11/033

(52) U.S. Cl. CPC C09D 11/40; C09D 11/328; C09D 11/38; C09D 11/037; C09D 11/033

(57) ABSTRACT

An ink set of the present disclosure includes a colored ink jet ink and a decoloring ink. The colored ink jet ink includes a leuco dye, a developer, and a dispersant, and the decoloring ink includes a solvent and water. The solvent includes a specific solvent component that has a Hansen solubility parameter that differs from the Hansen solubility parameter of the developer by an absolute value of less than or equal to 5.3. Preferably, the specific solvent component is a glycol ether or a glycol. Preferably, the leuco dye is a fluoran. Preferably, the developer is a compound containing a phenolic hydroxy group in the molecule.

The present application is based on, and claims priority from JP Application Serial Number 2022-047966, filed Mar. 24, 2022, the disclosure of which is hereby incorporated by reference herein in its entirety.

### BACKGROUND

### 1. Technical Field

The present disclosure relates to an ink set.

### 2. Related Art

In the related art, inks containing a leuco dye and a developer are known. These inks are often designed to include a desensitizer, thereby enabling decolorization to be achieved by the application of heat.

JP-A-2003-268248 discloses that with regard to an ink containing a leuco dye and a developer, decolorization is carried out with the use of an organic solvent.

Unfortunately, in some instances, the related-art method that uses an organic solvent presents a problem in that the color remains even after the decolorization treatment.

### SUMMARY

The present disclosure has been made to solve the problem described above, and the following application example is an embodiment of the present disclosure.

According to an application example of the present disclosure, an ink set includes a colored ink jet ink and a decoloring ink. The colored ink jet ink includes a leuco dye, a developer, and a dispersant, and the decoloring ink includes a solvent and water. The solvent includes a specific solvent component that has a Hansen solubility parameter that differs from the Hansen solubility parameter of the developer by an absolute value of less than or equal to 5.3.

### DESCRIPTION OF EXEMPLARY EMBODIMENTS

Preferred embodiments of the present disclosure will be described in detail below.

### 1 Ink Set

First, an ink set of the present disclosure will be described.

The ink set of the present disclosure includes a colored ink jet ink and a decoloring ink. The colored ink jet ink includes a leuco dye, a developer, and a dispersant. The decoloring ink includes a solvent and water.

The solvent that forms the decoloring ink includes a specific solvent component that has a Hansen solubility parameter that satisfies the following condition, with respect to the Hansen solubility parameter of the developer that forms the colored ink jet ink.

Specifically, the solvent includes a specific solvent component that has a Hansen solubility parameter that differs from the Hansen solubility parameter of the developer by an absolute value of less than or equal to 5.3. In other words, a relationship of |δA-δB|≤5.3 is satisfied, where δA is the Hansen solubility parameter of the specific solvent component, and δB is the Hansen solubility parameter of the developer.

As a result of the satisfaction of the condition, high affinity can be achieved between the specific solvent component and the developer, and, therefore, the leuco dye and the developer can be efficiently separated from each other when the decoloring ink is brought into contact with the colored ink jet ink or when the decoloring ink is brought into contact with a recorded area formed from the colored ink jet ink. Accordingly, decolorization can be suitably achieved. In particular, the retention of color after decolorization can be suitably prevented, and, therefore, recording media that has undergone decolorization can be suitably reused.

In contrast, in instances where the above-described condition is not satisfied, satisfactory results cannot be obtained. For example, if the value of |δA-δB| is excessively large, sufficient decolorization is not achieved by the decoloring ink, which leads to problems such as the retention of color, a need to use large amounts of the decoloring ink for decolorization, and an excessive length of time necessary for decolorization.

Regarding δA and δB, it is sufficient for the present disclosure that the relationship of |δA-δB|≤5.3 be satisfied, as described above. Preferably, a relationship of 0.0≤|δA-δB|≤3.5 may be satisfied, more preferably, a relationship of 0.1≤|δA-δB|≤3.0 may be satisfied, and even more preferably, a relationship of 0.2≤|δA-δB|≤2.8 may be satisfied.

In these cases, the above-described effects of the present disclosure are produced more prominently. In addition, the choice of specific solvent components that can be used is increased.

Note that in instances where the decoloring ink includes a plurality of types of components as the specific solvent components, δA to be employed is a mass-based weighted average of the values of the Hansen solubility parameters of the plurality of types of components, and in instances where the colored ink jet ink includes a plurality of types of developers, δB to be employed is a mass-based weighted average of the values of the Hansen solubility parameters of the plurality of types of components.

### 1-1 Colored Ink Jet Ink

The colored ink jet ink that forms the ink set of the present disclosure will now be described. The colored ink jet ink is an ink to be ejected by using an ink jet method.

The use of an ink jet method for performing the ejection enables suitable formation of a recorded area even if the recorded area is, for example, to be provided with a fine pattern. Furthermore, a recorded area can also be suitably formed on a curved surface portion and the like. Furthermore, excellent on-demand performance is provided, and, therefore, recorded areas with various patterns can be suitably formed. Furthermore, using an unnecessary amount of ink can be avoided. Accordingly, the use of an ink jet method is preferable also from the standpoint of resource conservation, for example.

Examples of ink jet methods include continuous methods, such as charge deflection methods; and on-demand methods, such as piezoelectric methods and bubble jet (registered trademark) methods.

The colored ink jet ink that forms the ink set of the present disclosure includes a leuco dye, a developer, and a dispersant.

### 1-1-1 Leuco Dye

The leuco dye is a coloring material that is substantially colorless by itself but, when the developer, which will be described later in detail, acts on the leuco dye, undergoes a change in its chemical structure to become colored.

Examples of the leuco dye include compounds containing a lactone ring in the molecule, such as triphenylmethanes, diphenylmethanes, spiropyrans, fluorans, and rhodaminelactams. One or a combination of two or more selected from these may be used.

In particular, it is preferable that the leuco dye be a fluoran. In this case, a suitable black color can be exhibited in a state in which the action of the developer is exerted. As a result, a color difference between before and after decolorization by the decoloring ink can be increased. Furthermore, such leuco dyes are particularly advantageous because black inks are widely used on various recording media and, therefore, have high demand as inks, and in addition, such leuco dyes are particularly advantageous for the reuse of recording media.

Examples of commercially available products of leuco dyes include CVL, Green DCF, Vermilion DCF, Red DCF, Orange DCF, TH-106, TH-107, TH-108, TH-109, CF-51, and D.L.M.B. (trade names, all manufactured by Hodogaya Chemical Co., Ltd.); DEBN, RED 500, RED 520, S-205, Black 100, Black 202, Black 305, ETAC, Blue 220, NIR Black 78, Green 300, and PINK 535 (trade names, all manufactured by Yamada Chemical Co., Ltd.); ODB, ODB-2, ODB-7, Black-15, Black-173, Blue-63, Blue-502, Green-40, Red-3, Red-40, MNSP, LCV, GN-2, GN-169, and GN-118 (trade names, all manufactured by Yamamoto Chemicals Inc.); and Pergascript Red I-6B and Pergascript Green I-2GN (trade names, both manufactured by Ciba Specialty Chemicals Corp.).

A content of the leuco dye in the colored ink jet ink is not particularly limited and is preferably 0.2 mass % or greater and 30.0 mass % or less, more preferably 0.5 mass % or greater and 25.0 mass % or less, and even more preferably 1.0 mass % or greater and 15.0 mass % or less.

### 1-1-2 Developer

The developer functions to act on the leuco dye, described above, thereby causing the leuco dye to develop a color.

Examples of the developer include compounds containing a phosphoric acid group in the molecule, such as phosphoric acids, phosphoric acid monoesters, and phosphoric acid diesters; and compounds containing a phenolic hydroxy group in the molecule, such as hydroxyacetophenone-based compounds, hydroxybenzophenone-based compounds, gallic acid ester-based compounds, benzenetriol-based compounds, bisphenol-based compounds, triphenol-based compounds, and cresol-based compounds. One or a combination of two or more selected from these may be used.

In particular, the developer is preferably a compound containing a phenolic hydroxy group in the molecule and more preferably a compound containing one or two benzene rings that contain a phenolic hydroxy group in the molecule.

In these cases, the pH of the colored ink jet ink can be easily adjusted to fall within a suitable range, and, consequently, the recorded area formed with the colored ink jet ink has enhanced color properties.

Examples of the compounds containing a phosphoric acid group in the molecule include monoalkyl phosphoric acid esters, dialkyl phosphoric acid esters, polyoxyethylene monoalkyl phosphoric acid esters, and polyoxyethylene dialkyl phosphoric acid esters.

Examples of the compounds containing a phenolic hydroxy group in the molecule include dihydroxyacetophenone, trihydroxyacetophenone, dihydroxybenzophenone, trihydroxybenzophenone, tetrahydroxybenzophenone, dihydrobenzoic acid, bisphenols, such as bisphenol A and bisphenol Z, hydroxyphenylalkyl-benzotriazole, methylenetris-p-cresol, and gallic acid alkyl esters.

Examples of the alkyl group that is present in the compounds containing a phosphoric acid group in the molecule and compounds containing a phenolic hydroxy group in the molecule include linear or branched alkyl groups, specific examples of which include methyl groups, ethyl groups, propyl groups, butyl groups, nonyl groups, lauryl groups, oleyl groups, and stearyl groups.

Examples of commercially available products of the compounds containing a phosphoric acid group in the molecule include Phosphanol Series (trade name, manufactured by Toho Chemical Industry Co., Ltd.), Plysurf Series (trade name, manufactured by DKS Co. Ltd.), and Newcol 565-PS (trade name, manufactured by Nippon Nyukazai Co., Ltd.). One or a combination of two or more selected from these may be used.

A content of the developer in the colored ink jet ink is not particularly limited and is preferably 0.02 mass % or greater and 15.0 mass % or less, more preferably 0.1 mass % or greater and 10.0 mass % or less, and even more preferably 0.5 mass % or greater and 4.0 mass % or less.

It is preferable that a relationship of 0.03≤XB/XA≤0.70 be satisfied, it is more preferable that a relationship of 0.05≤XB/XA≤0.50 be satisfied, and it is even more preferable that a relationship of 0.15≤XB/XA≤0.30 be satisfied, where XA is the content [mass %] of the leuco dye in the colored ink jet ink, and XB is the content [mass %] of the developer in the colored ink jet ink.

In these cases, an amount of the developer to be added can be reduced while the development of color is maintained, and, therefore, the resulting ink is superior in terms of environmental protection and cost reduction.

In the colored ink jet ink, the developer is present in a state in which at least a portion of the developer has reacted with the leuco dye.

The reaction between the leuco dye and the developer can be carried out suitably, for example, by heating a composition containing the leuco dye and the developer, or more specifically, by heating and melting a mixture of the leuco dye and the developer, in a process of producing the colored ink jet ink.

The heated and melted product of the leuco dye and the developer may be pulverized after being cooled, so that the product can be suitably used in the production of the colored ink jet ink.

It is preferable that the reaction product of the leuco dye and the developer that are included in the colored ink jet ink have an average particle size of 10 nm or greater and 1000 nm or less. The average particle size is more preferably 20 nm or greater and 500 nm or less and even more preferably 30 nm or greater and 300 nm or less.

### 1-1-3 Dispersant

The colored ink jet ink includes a dispersant that functions to disperse the leuco dye and the developer. As a result of the inclusion of the dispersant, the colored ink jet ink can have sufficiently high ejection stability associated with the ink jet method.

Examples of the dispersant include anionic dispersants and nonionic dispersants. One or a combination of two or more selected from these may be used. The dispersant may be a polymeric dispersant.

Preferred examples of the anionic dispersant include formalin condensates of aromatic sulfonic acid. Examples of the aromatic sulfonic acid in the formalin condensates of aromatic sulfonic acid include creosote oil sulfonic acid, cresol sulfonic acid, phenol sulfonic acid, β-naphthol sulfonic acid, alkyl naphthalene sulfonic acids, such as methyl naphthalene sulfonic acid and butyl naphthalene sulfonic acid, a mixture of β-naphthalene sulfonic acid and β-naphthol sulfonic acid, a mixture of cresol sulfonic acid and 2-naphthol-6-sulfonic acid, and lignin sulfonic acid and salts thereof.

Examples of the nonionic dispersant include ethylene oxide adducts of a phytosterol and ethylene oxide adducts of cholestanol.

In particular, it is preferable that the dispersant be a dispersing resin having a sulfonic acid structure. In this case, the pH of the colored ink jet ink can be easily adjusted to fall within a suitable range, and, consequently, the recorded area formed with the colored ink jet ink has enhanced color properties.

Examples of commercially available products of the dispersing resin having a sulfonic acid structure include Demol NL, Demol MS, Demol N, Demol RN, Demol RN-L, Demol SC-30, Demol SN-B, Demol SS-L, Demol T, and Demol T-45 (all manufactured by Kao Corporation) and ST 5005 (manufactured by Tosoh Finechem Corporation).

A weight average molecular weight of the dispersant is not particularly limited and is preferably 10,000 or greater and 20,000 or less and more preferably 12,000 or greater and 18,000 or less.

In these cases, an excellent dispersion-stabilizing-effect can be produced, and as a result, the colored ink jet ink can have enhanced ejection stability associated with the ink jet method.

A content of the dispersant in the colored ink jet ink is not particularly limited and is preferably 1.0 mass % or greater and 30.0 mass % or less, more preferably 2.0 mass % or greater and 25.0 mass % or less, and even more preferably 3.0 mass % or greater and 20.0 mass % or less.

It is preferable that a relationship of 0.3≤XC/XA≤5.0 be satisfied, it is more preferable that a relationship of 0.5≤XC/XA≤3.5 be satisfied, and it is even more preferable that a relationship of 0.7≤XC/XA≤2.0 be satisfied, where XA is the content [mass %] of the leuco dye in the colored ink jet ink, and XC is the content [mass %] of the dispersant in the colored ink jet ink.

In these cases, the dispersion of the leuco dye and the developer in the colored ink jet ink can be suitably stabilized, which results in improved storage stability.

### 1-1-4 Dispersion Medium

The colored ink jet ink includes a dispersion medium that functions to disperse the leuco dye and the developer. The dispersion medium may be one that serves as a solvent that dissolves one or more other components.

As a result of the inclusion of the dispersion medium, the colored ink jet ink can have sufficiently high ejection stability associated with the ink jet method.

Examples of the dispersion medium include water and various organic solvents. One or a combination of two or more selected from these may be used. Preferably, the dispersion medium is water.

In particular, a ratio of water in the entirety of the dispersion medium included in the colored ink jet ink is preferably greater than or equal to 70 mass %, more preferably greater than or equal to 90 mass %, and even more preferably greater than or equal to 95 mass %. Note that the upper limit of the ratio of water in the entirety of the dispersion medium included in the colored ink jet ink is 100 mass %.

The dispersion medium that forms the colored ink jet ink may include an organic solvent. In this instance, it is preferable that the Hansen solubility parameter of the organic solvent differ from the Hansen solubility parameter of the developer by an absolute value of greater than or equal to 6.0.

A content of the dispersion medium in the colored ink jet ink is not particularly limited and is preferably 40.0 mass % or greater and 95.0 mass % or less, more preferably 45.0 mass % or greater and 90.0 mass % or less, and even more preferably 55.0 mass % or greater and 85.0 mass % or less.

### 1-1-5 Surfactant

The colored ink jet ink may further include a surfactant. In this case, the colored ink jet ink can, for example, have improved wettability with respect to recording media.

Examples of the surfactant include silicon-based surfactants, fluorosurfactants, and polyoxyethylene derivatives, which are nonionic surfactants. One or a combination of two or more selected from these may be used.

Examples of the silicon-based surfactants include polyester-modified silicone and polyether-modified silicone. Examples of commercially available products of the silicon-based surfactants include BYK-347 and 348 and BYK-UV 3500, 3510, 3530, and 3570 (all manufactured by BYK Japan KK).

Examples of the fluorosurfactants include fluorine-modified polymers. Examples of commercially available products of the fluorosurfactants include BYK-340 (manufactured by BYK Japan KK).

Examples of the polyoxyethylene derivatives include acetylene glycol-based surfactants. Examples of commercially available products of the polyoxyethylene derivatives include Surfynol 82, 104, 465, 485, and TG (all manufactured by Air Products Japan Inc.), Olfine STG and E1010 (both are manufactured by Nissin Chemical Co., Ltd.), Nissan Nonion A-10R and A-13R (both are manufactured by NOF Corporation), Flowlen TG-740W and D-90 (manufactured by Kyoeisha Chemical Co., Ltd.), and Noigen CX-100 (manufactured by DKS Co. Ltd.).

A content of the surfactant in the colored ink jet ink is not particularly limited and is preferably 0.1 mass % or greater and 5.0 mass % or less, more preferably 0.2 mass % or greater and 4.0 mass % or less, and even more preferably 0.3 mass % or greater and 3.5 mass % or less.

### 1-1-6 Other Components

The colored ink jet ink may include one or more components other than the components described above. Hereinafter, in this section, such components will also be referred to as “other components”.

Examples of the other components include humectants, pH-adjusting agents, chelating agents, preservative/antifungal agents, corrosion inhibitors, antioxidants, UV absorbers, oxygen absorbers, and penetrating agents. One or a combination of two or more selected from these may be used.

Note that a content of the other components in the colored ink jet ink is preferably less than or equal to 10.0 mass %, more preferably less than or equal to 7.0 mass %, and even more preferably less than or equal to 5.0 mass %.

### 1-1-7 Other Conditions

The pH of the colored ink jet ink at 25° C. is preferably 3.0 or greater and 11.0 or less, more preferably 5.0 or greater and 9.0 or less, and even more preferably 6.0 or greater and 8.0 or less.

In these cases, the recorded area formed from the colored ink jet ink exhibits enhanced color properties before coming into contact with the decoloring ink.

A viscosity of the colored ink jet ink at 25° C. is preferably 2 mPa·s or greater and 10 mPa·s or less, more preferably 3 mPa·s or greater and 8 mPa·s or less, and even more preferably 4 mPa·s or greater and 6 mPa·s or less.

In these cases, the colored ink jet ink has enhanced ejection stability associated with the ink jet method.

Note that the viscosity can be measured at 25° C. with a viscoelastometer (e.g., Visco 6800, manufactured by Atago Co., Ltd.), by reading the viscosity at a shear rate of 10 [s^{-1]}. The ink set of the present disclosure may include a plurality of types of colored ink jet inks.

### 1-2 Decoloring Ink

The decoloring ink that forms the ink set of the present disclosure will now be described. The decoloring ink that forms the ink set of the present disclosure includes a solvent and water.

It is preferable that the decoloring ink be an ink jet ink. In this case, the decoloring ink can suitably, with enhanced on-demand performance, be ejected and applied to recorded matter having thereon a recorded area formed from the colored ink jet ink.

More specifically, for example, the decoloring ink may be ejected and applied to recorded matter having thereon a recorded area formed from the colored ink jet ink, in a pattern that corresponds to that of the recorded area. In this case, the recorded area can be suitably decolorized while an amount of the decoloring ink to be used is reduced or at least not increased.

In another instance, for example, the decoloring ink may be selectively ejected and applied to recorded matter having thereon a recorded area formed from the colored ink jet ink, in a manner such that the decoloring ink is applied only to a portion or portions of the recorded area. In this case, only the portion or portions of the colored recorded area can be selectively decolorized to form a colored recorded area with a new pattern.

Furthermore, since the decoloring ink can be selectively applied to only the target region, the amount of the decoloring ink to be used can be reduced. Accordingly, such an instance is preferable also from the standpoint of resource conservation and cost reduction, for example. Furthermore, size reduction of an apparatus for performing the decolorization treatment can be achieved.

### 1-2-1 Solvent

The solvent is formed of one or more organic solvent components, which include a specific solvent component that has a Hansen solubility parameter that satisfies the specified relationship with the Hansen solubility parameter of the developer.

As a result of the inclusion of the solvent, the leuco dye and the developer can be efficiently separated from each other when the decoloring ink is brought into contact with the colored ink jet ink or when the decoloring ink is brought into contact with a recorded area formed from the colored ink jet ink. Accordingly, decolorization can be suitably achieved.

The specific solvent component may be any solvent component that has a Hansen solubility parameter δA that satisfies the above-described relationship with the Hansen solubility parameter δB of the developer, as described above. Preferably, the specific solvent component satisfies the following relationship with the leuco dye that forms the colored ink jet ink. Specifically, it is preferable that a relationship of 0.0≤|δA-δC|≤8.5 be satisfied, it is more preferable that a relationship of 0.0≤|δA-δC|≤8.0 be satisfied, and it is even more preferable that a relationship of 0.1≤|δA-δC|≤5.5 be satisfied, where δA is the Hansen solubility parameter of the specific solvent component, and δC is the Hansen solubility parameter of the leuco dye.

In these cases, the color provided by the colored ink jet ink can be suitably removed by the decoloring ink.

Note that in instances where the colored ink jet ink includes a plurality of types of leuco dyes, δC to be employed is a mass-based weighted average of the values of the Hansen solubility parameters of the plurality of types of components.

Examples of the specific solvent component include glycol ethers and glycols, depending on the type of the developer included in the colored ink jet ink. Examples of the glycol ethers include triethylene glycol monomethyl ether, triethylene glycol monoethyl ether, and triethylene glycol monobutyl ether, and examples of the glycols include diethylene glycol, dipropylene glycol, and 3-methyl-1,5-pentanediol. One or a combination of two or more selected from these may be used.

In particular, it is preferable that the specific solvent component be a glycol ether or a glycol. More preferably, the specific solvent component be one or more selected from the group consisting of triethylene glycol monomethyl ether, triethylene glycol monoethyl ether, triethylene glycol monobutyl ether, diethylene glycol, dipropylene glycol, and 3-methyl-1,5-pentanediol.

In these cases, the leuco dye and the developer can be more efficiently separated from each other when the decoloring ink is brought into contact with the colored ink jet ink or when the decoloring ink is brought into contact with a recorded area formed from the colored ink jet ink. Accordingly, decolorization can be more suitably achieved. Furthermore, these solvent components are unlikely to damage the structural members of various devices, such as ink jet devices, and, consequently, unwanted deformation, swelling, and the like of such structural members can be more effectively prevented. Accordingly, the decolorization with the use of the decoloring ink can be accomplished more consistently and suitably.

A content of the specific solvent component in the decoloring ink is preferably 5.0 mass % or greater and 70.0 mass % or less, more preferably 10.0 mass % or greater and 60.0 mass % or less, and even more preferably 20.0 mass % or greater and 50.0 mass % or less. In these cases, the above-described effects of the present disclosure can be produced more prominently while an increase in the production cost of the decoloring solvent and the ink set is inhibited.

Regarding the solvent that forms the decoloring ink, it is sufficient that the solvent include the specific solvent component described above. Optionally, the solvent may further include one or more other solvent components, in addition to the specific solvent component. Hereinafter, in this section, such solvent components will also be referred to as “other solvent components”.

Note that a ratio of the other solvent components to the total of the solvents that form the decoloring ink is preferably less than or equal to 10.0 mass %, more preferably less than or equal to 5.0 mass %, and even more preferably less than or equal to 3.0 mass %.

A content of the solvent in the decoloring ink is preferably 5.0 mass % or greater and 77.0 mass % or less, more preferably 10.0 mass % or greater and 63.0 mass % or less, and even more preferably 20.0 mass % or greater and 51.5 mass % or less.

### 1-2-2 Water

The decoloring ink includes water. The water functions to ensure flowability of the decoloring ink, for example.

A content of the water in the decoloring ink is preferably 20.0 mass % or greater and 94.5 mass % or less, more preferably 35.0 mass % or greater and 89.0 mass % or less, and even more preferably 47.0 mass % or greater and 78.5 mass % or less.

### 1-2-3 Surfactant

The decoloring ink may further include a surfactant. In this case, the decoloring ink can, for example, have improved wettability with respect to recording media.

Examples of the surfactant include silicon-based surfactants, fluorosurfactants, and polyoxyethylene derivatives, which are nonionic surfactants. One or a combination of two or more selected from these may be used.

Examples of the silicon-based surfactants include polyester-modified silicone and polyether-modified silicone. Examples of commercially available products of the silicon-based surfactants include BYK-347 and 348 and BYK-UV 3500, 3510, 3530, and 3570 (all manufactured by BYK Japan KK).

Examples of the fluorosurfactants include fluorine-modified polymers. Examples of commercially available products of the fluorosurfactants include BYK-340 (manufactured by BYK Japan KK).

Examples of the polyoxyethylene derivatives include acetylene glycol-based surfactants. Examples of commercially available products of the polyoxyethylene derivatives include Surfynol 82, 104, 465, 485, and TG (all manufactured by Air Products Japan Inc.), Olfine STG and E1010 (both are manufactured by Nissin Chemical Co., Ltd.), Nissan Nonion A-10R and A-13R (both are manufactured by NOF Corporation), Flowlen TG-740W and D-90 (manufactured by Kyoeisha Chemical Co., Ltd.), and Noigen CX-100 (manufactured by DKS Co. Ltd.).

A content of the surfactant in the decoloring ink is not particularly limited and is preferably 0.1 mass % or greater and 5.0 mass % or less, more preferably 0.2 mass % or greater and 4.0 mass % or less, and even more preferably 0.3 mass % or greater and 3.5 mass % or less.

### 1-2-4 Other Components

The decoloring ink may include one or more components other than the components described above. Hereinafter, in this section, such components will also be referred to as “other components”.

Examples of the other components include humectants, pH-adjusting agents, chelating agents, preservative/antifungal agents, corrosion inhibitors, antioxidants, UV absorbers, oxygen absorbers, and penetrating agents. One or a combination of two or more selected from these may be used.

Note that a content of the other components in the decoloring ink is preferably less than or equal to 10.0 mass %, more preferably less than or equal to 7.0 mass %, and even more preferably less than or equal to 5.0 mass %.

### 1-2-5 Other Conditions

A viscosity of the decoloring ink at 25° C. is preferably 2 mPa·s or greater and 10 mPa·s or less, more preferably 3 mPa·s or greater and 8 mPa·s or less, and even more preferably 4 mPa·s or greater and 6 mPa·s or less.

In these cases, the decoloring ink has, for example, enhanced ejection stability associated with the ink jet method. The ink set of the present disclosure may include a plurality of types of decoloring inks.

### 1-3 Other Features

For the ink set of the present disclosure, it is sufficient to include the colored ink jet ink and the decoloring ink described above. Optionally, the ink set may further include one or more other features.

For example, the ink set of the present disclosure may include, in addition to the colored ink jet ink and the decoloring ink described above, at least one ink that includes a non-leuco-dye colorant without including any leuco dye.

### 2 Method For Using Ink Set

Now, a method for using the present disclosure will be described.

The ink set of the present disclosure can be used, for example, in a usage method including a recorded area formation step and a decolorization step. The recorded area formation step is a step of forming a recorded area having a predetermined pattern, by applying the colored ink jet ink to a recording medium by using an ink jet method. The decolorization step is a step of applying the decoloring ink to the recording medium having the recorded area formed thereon (i.e., recorded matter), to decolorize at least a portion of the recorded matter.

### 2-1 Recorded Area Formation Step

In the recorded area formation step, a recorded area having a predetermined pattern is formed by applying the colored ink jet ink to a recording medium by using an ink jet method. In this step, a plurality of types of colored ink jet inks may be used.

Furthermore, in this step, one or more inks that include a non-leuco-dye colorant without including any leuco dye may be used, in addition to the above-described colored ink jet ink that includes a leuco dye, a developer, and a dispersant. Hereinafter, such inks will be referred to as “other coloring inks”.

In the instance where one or more other coloring inks are used in addition to the colored ink jet ink, these inks may be applied in a manner such that the inks are superimposed on each other on a recording medium.

### 2-2 Decolorization Step

In the decolorization step, the decoloring ink is applied to the recording medium having the recorded area formed thereon. As a result, the leuco dye in the region to which the decoloring ink has been applied is decolorized.

In this step, it is sufficient that the decoloring ink be applied to at least a portion of the recorded area to which the colored ink jet ink has been applied. That is, the decoloring ink may be applied to the entirety of the recorded area or may be applied only to a portion of the recorded area.

In instances where the recorded area formed from the colored ink jet ink is decolorized in a manner such that the recorded area does not remain on most of the surface of the recording medium on which the recorded area has been provided (e.g., 80% or more of the surface of the recording medium), the recording medium can be suitably reused. For example, the recording medium can be suitably reused as paper for ink jet printers in offices, homes, and the like.

Furthermore, in instances where the decoloring ink is applied to a region to which the colored ink jet ink and one or more other coloring inks have been applied in a superimposing manner in the recorded area formation step, it is possible to selectively decolorize only the color provided by the colored ink jet ink. Consequently, the color provided by the one or more other coloring inks can be retained on the recording medium that has undergone the step. In this case, the recorded area before the decolorization step and the recorded area after the decolorization step can have different respective colorations, for example.

Furthermore, in the usage method described above, the recorded area formation step and the decolorization step may be repeatedly performed.

Although preferred embodiments of the present disclosure have been described, it should be noted that the present disclosure is not limited to the embodiments.

### EXAMPLES

Specific examples of the present disclosure will now be described.
3 Preparation of Colored Ink Jet Ink

### Preparation Example A1

First, a leuco dye and a developer were heated and melted and thereafter cooled. The leuco dye used was S-205 (manufactured by Yamada Chemical Co., Ltd.), and the developer used was bisphenol A. Subsequently, the resultant was milled in a dry ball mill to form a colorant powder.

The colorant powder, a dispersant, and purified water were mixed together in a predetermined ratio, and the mixture was stirred at 3000 rpm in a high-shear mixer (manufactured by Silverson) to form a slurry. The dispersant used was a naphthalene sulfonic acid-butyl naphthalene sulfonic acid copolymer, namely, Demol SN-B (manufactured by Kao Corporation), which is a dispersing resin having a sulfonic acid structure.

Subsequently, the produced slurry and 0.5-mm-diameter glass beads were added to a bead mill (LMZ015, manufactured by Ashizawa Finetech Ltd.) and then stirred and dispersed while being cooled with water. In this manner, a stock solution for ink jet ink production, specifically, an aqueous ink jet ink composition, was produced.

Glycerin, a surfactant, and purified water were added in a predetermined ratio to the stock solution for ink jet ink production. The surfactant used was E1010 (manufactured by NOF Corporation). Accordingly, a colored ink jet ink having the composition shown in Table 1 was prepared.

The reaction product of the leuco dye and the developer in the colored ink jet ink had an average particle size of 130 nm.

### Preparation Examples A2 to A9

Colored ink jet inks were prepared as in Preparation Example A1, except that the types and amounts of the components used in the preparation of the colored ink jet ink were changed such that the compositions shown in Table 1 were achieved.

### 4 Production of Decoloring Ink

Decoloring inks were prepared by forming mixtures with the respective solvents shown in Table 2.

### Preparation Example B1

A specific solvent component, a surfactant, and purified water were mixed together in the ratio shown in Table 2. The specific solvent component used was triethylene glycol monomethyl ether, and the surfactant used was E1010 (manufactured by NOF Corporation). Accordingly, a decoloring ink was prepared.

### Preparation Examples B2 to B10

Decoloring inks were prepared as in Preparation Example B1, except that the types and amounts of the components used in the preparation of the decoloring ink were changed such that the compositions shown in Table 2 were achieved.

The conditions for the preparation of the inks in the above-mentioned preparation examples are shown together in Table 1 and Table 2. In the tables, “S205” denotes S-205 (manufactured by Yamada Chemical Co., Ltd.), which is a leuco dye; “BK400” denotes BK400 (manufactured by BLD Pharmatech), which is a leuco dye; “SN-B” denotes Demol SN-B (weight average molecular weight: 13000, manufactured by Kao Corporation), which is a dispersing resin having a sulfonic acid structure and was used as a dispersant; “ST5005” denotes ST 5005 (weight average molecular weight: 19000, manufactured by Tosoh Finechem Corporation), which is a dispersing resin having a sulfonic acid structure and was used as a dispersant; “EP” denotes Demol EP (weight average molecular weight: 7500, manufactured by Kao Corporation), which is a dispersing resin having no sulfonic acid structure and was used as a dispersant; “E1010” denotes E1010 (manufactured by Nissin Chemical Co., Ltd.), which was used as a surfactant; “MTG” denotes triethylene glycol monomethyl ether; “BTG” denotes triethylene glycol monobutyl ether; “DEG” denotes diethylene glycol; “DPG” denotes dipropylene glycol; and “1,3PG” denotes 3-methyl-1,5-pentanediol. In Table 1 and Table 2, the contents of the components are in mass %. Furthermore, in Table 1 and Table 2, “HSP” denotes the Hansen solubility parameter of the leuco dyes, the developers, and the solvent components. Furthermore, in Table 2, “ΔHSP_{BA}” denotes the absolute value of the difference between the Hansen solubility parameter of each of the solvent components and the Hansen solubility parameter of bisphenol A; “ΔHSP_{BZ}” denotes the absolute value of the difference between the Hansen solubility parameter of each of the solvent components and the Hansen solubility parameter of bisphenol Z; “ΔHSP_{S205}” denotes the absolute value of the difference between the Hansen solubility parameter of each of the solvent components and the Hansen solubility parameter of S-205 (manufactured by Yamada Chemical Co., Ltd.), which is a leuco dye; and “ΔHSP_{BK400}” denotes the absolute value of the difference between the Hansen solubility parameter of each of the solvent components and the Hansen solubility parameter of BK400 (manufactured by BLD Pharmatech), which is a leuco dye.

TABLE 1

| | Components | | | Preparation Examples | | | | | | | | |
|---|---|---|---|---|---|---|---|---|---|---|---|---|
| | | | HSP | A1 | A2 | A3 | A4 | A5 | A6 | A7 | A8 | A9 |
| Composition | Leuco dye | S205 | 20.3 | 5.0 | 10.0 | 15.0 | 1.0 | — | 5.0 | 5.0 | 5.0 | 5.0 |
| | | BK400 | 20.6 | — | — | — | — | 5.0 | — | — | — | — |
| | Developer | Bisphenol | 22.6 | 1.0 | 2.0 | 3.0 | 0.5 | 1.0 | — | 1.0 | — | 1.0 |
| | | A | | | | | | | | | | |
| | | Bisphenol | 22.6 | — | — | — | — | — | 0.5 | — | 1.0 | — |
| | | Z | | | | | | | | | | |
| | Dispersant | SN-B | — | 6.0 | 12.0 | 18.0 | 3.0 | 6.0 | 5.5 | — | — | — |
| | | ST5005 | — | — | — | — | — | — | — | 6.0 | 6.0 | — |
| | | EP | — | — | — | — | — | — | — | — | — | 6.0 |
| | Humectant | Glycerin | — | 10.0 | 10.0 | 10.0 | 10.0 | 10.0 | 10.0 | 10.0 | 10.0 | 10.0 |
| | Surfactant | E1010 | — | 2.0 | 2.0 | 2.0 | 2.0 | 2.0 | 2.0 | 2.0 | 2.0 | 2.0 |
| | Water | | — | 76.0 | 64.0 | 52.0 | 83.0 | 76.0 | 77.0 | 76.0 | 76.0 | 76.0 |

| | | | | | | | | | | |
|---|---|---|---|---|---|---|---|---|---|---|
| Average particle size [nm] of reaction | — | 130 | 130 | 130 | 130 | 130 | 130 | 150 | 150 | 150 |
| product of leuco dye and developer | | | | | | | | | | |

TABLE 2

| | Components | | | | | | | Preparation Examples | | | | | | | | | |
|---|---|---|---|---|---|---|---|---|---|---|---|---|---|---|---|---|---|
| | | | HSP | ΔHSP_{BA} | ΔHSP_{BZ} | ΔHSP_{S205} | ΔHSP_{BK400} | B1 | B2 | B3 | B4 | B5 | B6 | B7 | B8 | B9 | B10 |
| Compo- | Solvent | MTG | 21.4 | 1.2 | 1.2 | 1.1 | 0.8 | 30.0 | — | — | — | — | 20.0 | 50.0 | 20.0 | — | — |
| sition | | BTG | 20.4 | 2.2 | 2.2 | 0.1 | 0.2 | — | 30.0 | — | — | — | — | — | 20.0 | — | — |
| | | MPD | 25.5 | 2.9 | 2.9 | 5.2 | 4.9 | — | — | 30.0 | — | — | — | — | — | — | — |
| | | DPG | 26.4 | 3.8 | 3.8 | 6.1 | 5.8 | — | — | — | 30.0 | — | — | — | — | — | — |
| | | DEG | 27.9 | 5.3 | 5.3 | 7.6 | 7.3 | — | — | — | — | 30.0 | — | — | — | — | — |
| | | 1,3PG | 31.7 | 9.1 | 9.1 | 11.4 | 11.1 | — | — | — | — | — | — | — | — | 30.0 | — |
| | | PG | 29.1 | 6.5 | 6.5 | 8.8 | 8.5 | — | — | — | — | — | — | — | — | — | 30.0 |
| | Sur- | E1010 | — | — | — | — | — | 2.0 | 2.0 | 2.0 | 2.0 | 2.0 | 2.0 | 2.0 | 2.0 | 2.0 | 2.0 |
| | factant | | | | | | | | | | | | | | | | |

| | | | | | | | | | | | | | | | |
|---|---|---|---|---|---|---|---|---|---|---|---|---|---|---|---|
| Water | 47.8 | — | — | — | — | 68.0 | 68.0 | 68.0 | 68.0 | 68.0 | 78.0 | 48.0 | 58.0 | 68.0 | 68.0 |

### 5 Production of Ink Set

### Example 1

An ink set was obtained by combining the colored ink jet ink prepared in Preparation Example A1 with the decoloring ink prepared in Preparation Example B1.

### Examples 2 to 15

Ink sets were obtained as in Example 1, except that the combination of the colored ink jet ink and the decoloring ink was changed as shown in Table 3.

### Comparative Examples 1 to 3

Ink sets were obtained as in Example 1, except that the combination of the colored ink jet ink and the decoloring ink was changed as shown in Table 3.

### 6 Evaluations

The ink sets of the Examples and the Comparative Examples were evaluated as described below.

### 6-1 Ejection Stability

First, the colored ink jet ink and the decoloring ink that formed the ink set obtained in each of the Examples and Comparative Examples were each introduced into an ink cartridge for an ink jet recording apparatus, and subsequently, the ink cartridges were installed in a recording apparatus (an ink jet printer PX-G930, manufactured by Seiko Epson Corporation).

Subsequently, after confirmation was made that all the nozzles were able to perform ejection normally, continuous decoloring printing was performed in an environment at 50° C. and 60% RH for 60 minutes. Subsequently, the number of missing nozzles was counted, and evaluations were made according to the following criteria. Fewer missing nozzles, that is, more normal nozzles, indicate higher ejection stability.

A: There were no missing nozzles.

B: 90% or more and less than 100% of the nozzles were normal.

C: 50% or more and less than 90% of the nozzles were normal.

D: Less than 50% of the nozzles were normal.

### 6-2 Optical Density (OD) Reduction Ratio

First, the colored ink jet ink and the decoloring ink that formed the ink set obtained in each of the Examples and Comparative Examples were each introduced into an ink cartridge for an ink jet recording apparatus, and subsequently, the ink cartridges were installed in a recording apparatus (an ink jet printer PX-G930, manufactured by Seiko Epson Corporation).

Subsequently, after confirmation was made that all the nozzles were able to perform ejection normally, solid area printing that used the colored ink jet ink was performed on plain paper (plain paper manufactured by Fuji Xerox Co., Ltd.), which was used as a recording medium.

The recording medium on which solid area printing was performed with the colored ink jet ink was sufficiently dried at room temperature. Subsequently, colorimetry was performed on the recorded area of the recorded matter with a spectrodensitometer FD-7 (manufactured by Konica Minolta, Inc.) to measure OD values based on the Lab color space.

Next, solid area printing that used the decoloring ink was performed on the recording medium on which solid area printing had been performed with the colored ink jet ink, that is, recorded matter.

The recording medium on which solid area printing was performed with the decoloring ink was sufficiently dried at room temperature. Subsequently, colorimetry was performed on the recorded area of the recorded matter with a spectrodensitometer FD-7 (manufactured by Konica Minolta, Inc.) to measure OD values based on the Lab color space.

Based on these measurement results, the ratio between the OD values of the recorded area of the recorded matter before and after being decolorized by the decoloring ink was determined, and evaluations were made according to the following criteria. Greater OD reduction ratios indicate better decolorization performance by the decoloring ink.

A: The OD reduction ratio was 90% or greater.

B: The OD reduction ratio was 85% or greater and less than 90%.

C: The OD reduction ratio was less than 85%.

### 6-3 Decolorization Time

When the above-described evaluations of Section 6-2 were performed, the following measurement was also performed. Immediately after the recording medium having the decoloring ink applied thereto was ejected from the ink jet printer, a stopwatch was started. The decoloring-ink-applied surface was visually examined, and at the time at which the decoloring-ink-applied surface became decolorized, the stopwatch was stopped. In this manner, the time that elapsed before the applied surface became decolorized was measured, and evaluations were made according to the following criteria. Smaller values of the time indicate better decoloring properties of the decoloring ink.

A: The decolorization time was less than 1 minute.

B: The decolorization time was 1 minute or more and less than 30 minutes.

C: The decolorization time was 30 minutes or more, or decolorization was not achieved.

### 6-4 Deformation of Structural Member

A rubber member that was one of the structural members of the ink jet printer (PX-G930, manufactured by Seiko Epson Corporation) and was a member that was to come into contact with inks was sealed in a 313a pack for evaluation, together with each of the decoloring inks that formed the ink set that was prepared in each of the Examples and Comparative Examples. Thereafter, the sealed pack was allowed to stand in a constant-temperature chamber at 60° C.

Two weeks later, the rubber member was removed from the 313a pack for evaluation and visually examined to determine the presence or absence of deformation, and evaluations were made according to the following criteria.

A: No deformation was observed in the structural member.

B: Deformation was observed in the structural member.

These results, as well as the combination of the inks that formed the ink set of each of the Examples and Comparative Examples, are shown in Table 3.

TABLE 3

| | | | Examples | | | | | | | | |
|---|---|---|---|---|---|---|---|---|---|---|---|
| | | | 1 | 2 | 3 | 4 | 5 | 6 | 7 | 8 | 9 |
| Combina- | Colored | | A1 | A1 | A1 | A1 | A1 | A1 | A1 | A1 | A2 |
| tion in | ink jet ink | | | | | | | | | | |
| ink set | Decoloring ink | | B1 | B2 | B3 | B4 | B5 | B6 | B7 | B8 | B1 |
| \|δA − δB\| | | | 1.2 | 2.2 | 2.9 | 3.8 | 5.3 | 1.2 | 1.2 | 1.7 | 1.2 |
| \|δA − δC\| | | | 1.1 | 0.1 | 5.2 | 6.1 | 7.6 | 1.1 | 1.1 | 0.6 | 1.1 |
| Evalu- | Ejection | Colored ink | A | A | A | A | A | A | A | A | A |
| ations | stability | jet ink | | | | | | | | | |
| | | Decoloring | A | A | A | A | A | A | A | A | A |
| | | ink | | | | | | | | | |
| | OD reduction ratio | | A | A | B | B | A | B | A | A | A |
| | Decolorization time | | A | A | B | B | B | A | A | A | A |
| | Deformation of | | A | A | A | A | A | A | A | A | A |
| | structural member | | | | | | | | | | |
| | | | | | | | | | Comparative | | |
| | | | Examples | | | | | | Examples | | |
| | | | 10 | 11 | 12 | 13 | 14 | 15 | 1 | 2 | 3 |
| Combina- | Colored | | A3 | A4 | A5 | A6 | A7 | A8 | A1 | A1 | A9 |
| tion in | ink jet ink | | | | | | | | | | |
| ink set | Decoloring ink | | B1 | B1 | B1 | B1 | B1 | B1 | B9 | B10 | B9 |
| \|δA − δB\| | | | 1.2 | 1.2 | 1.2 | 1.2 | 1.2 | 1.2 | 9.1 | 6.5 | 9.1 |
| \|δA − δC\| | | | 1.1 | 1.1 | 0.8 | 1.1 | 1.1 | 1.1 | 11.4 | 8.8 | 11.4 |
| Evalu- | Ejection | Colored ink | A | A | A | A | B | B | A | A | A |
| ations | stability | jet ink | | | | | | | | | |
| | | Decoloring | A | A | A | A | A | A | A | A | A |
| | | ink | | | | | | | | | |

| | | | | | | | | | |
|---|---|---|---|---|---|---|---|---|---|
| OD reduction ratio | B | A | A | A | A | A | C | C | C |
| Decolorization time | A | A | A | A | A | A | C | C | C |
| Deformation of | A | A | A | A | A | A | A | A | A |
| structural member | | | | | | | | | |

As demonstrated in Table 3, excellent results were obtained in the present disclosure. In contrast, satisfactory results could not be obtained in the Comparative Examples.

What is claimed is:

1. An ink set comprising:
a colored ink jet ink including a leuco dye, a developer, and a dispersant; and
a decoloring ink including a solvent and water, wherein
the solvent includes a specific solvent component that has a Hansen solubility parameter that differs from the Hansen solubility parameter of the developer by an absolute value of less than or equal to 5.3.

2. The ink set according to claim 1, wherein the specific solvent component is a glycol ether or a glycol.

3. The ink set according to claim 1, wherein the leuco dye is a fluoran.

4. The ink set according to claim 1, wherein the developer is a compound containing a phenolic hydroxy group in a molecule.

5. The ink set according to claim 1, wherein the dispersant is a dispersing resin having a sulfonic acid structure.

6. The ink set according to claim 1, wherein the dispersant has a weight average molecular weight of 10,000 or greater and 20,000 or less.

7. The ink set according to claim 1, wherein the decoloring ink is an ink jet ink.
